(19) United States
(12) Patent Application Publication
(10) Pub. No.: US 2023/0240281 A1
(43) Pub. Date: Aug. 3, 2023

(54) METHODS AND SYSTEMS FOR REPELLING FISH EATING PREDATORS

(71) Applicant: SIGNIFY HOLDING B.V., EINDHOVEN (NL)

(72) Inventors: MARC ANDRE DE SAMBER, LOMMEL (BE); GIOVANNI CENNINI, WAALRE (NL)

(21) Appl. No.: 18/023,834

(22) PCT Filed: Sep. 2, 2021
(86) PCT No.: PCT/EP2021/074240

§ 371 Date: Feb. 28, 2023

(30) Foreign Application Priority Data
Sep. 3, 2020 (EP) 20194285.1

(51) Int. Cl. A01M 29/10; A01K 61/10; A01M 29/16; H04N 9/31

(52) U.S. Cl. CPC A01M 29/10; A01K 61/10; A01M 29/16; H04N 9/31

(57) ABSTRACT

This disclosure relates to methods and systems for repelling one or more fish eating predators (4) from a fish-containing area (6) within a sea, fjord, river or lake, wherein a moving image of a predator (18) of the one or more fish eating predators (4) is provided at and/or near a boundary of the fish-containing area (6).

### FIELD OF THE INVENTION

This disclosure relates to methods and systems for repelling one or more fish eating predators from a fish-containing area within a sea, fjord, river or lake. In particular to such methods and wherein a moving image of a predator of the one or more fish eating predators is provided at and/or near a boundary of the fish-containing area. This disclosure also relates to systems configured to provide such a moving image.

### BACKGROUND OF THE INVENTION

Pinnipeds, such as sea lions, seals and sea leopards are notorious salmon predators, and are becoming more abundantly present globally.

For example, Otaria flavescens (South American sea lion) lives along the Chilean coast with a population estimate of 165,000. According to the most recent surveys in northern and southern Chile the sealing period of the middle twentieth century that left a significant decline in sea lion population is recovering. The recovery is occasioned by less hunting, otariids rapid population growth, legislation on nature reserves, and new food resources.

A major new food resource comes from the artificial cultivation of fish, such as salmon, offshore. Unfortunately, this creates an annoying situation. To illustrate, sea cages with thousands of densely packed fish, in the natural habitat of the sea lions, create an extremely easy prey for fierce predators, such as sea lions, seals and sea leopards, leading to productivity losses.

It is reported that the South American sea lion, Otaria flavescens, frequently attacks salmon farms (see Buschmann et al.; ICES Journal of Marine Science, Volume 63, Issue 7, 2006, Pages 1338-1345).

In general, it is not allowed to hunt (kill) the seals, sea lions, and sea leopards, therefore other measures such as strong fencing are required to keep them out of the fish-containing sea cages. However, still lots of yield is lost and damage to the sea cages occurs.

Also presence of the pinnipeds around the sea cages can disturb the fish and cause stress in the fish population, which negatively impacts productivity.

US 2018/0263237 A1 discloses a system and method of repelling aquatic mammals from an area of water. The system utilizes a speaker to transmit the sounds of predators into the area of water to repel mammals from the area and to deter mammals from returning to the area. The system includes a timer module programmed to repetitively transmit predator sounds on a time delay. By utilizing periodic intervals of predator sounds, the system and method prevent mammals from becoming conditioned to the predator sounds, thereby maintaining the effectiveness of the system over a prolonged period of time.

However, the inventors have found that the effectiveness of such system and method can be significantly improved.

### SUMMARY OF THE INVENTION

Therefore, one aspect of this disclosure relates to a method for repelling one or more fish eating predators from a fish-containing area within a sea, fjord, river or lake. The method comprises providing a moving image of a predator of the one or more fish eating predators at and/or near a boundary of the fish-containing area.

Another aspect of this disclosure relates to an aquaculture system that is configured to repel one or more fish eating predators from a fish-containing area. The system comprises one or more enclosures for keeping fish within the fish-containing area within a sea, fjord, river or lake and an image provisioning system for providing a moving image of a predator of the one or more fish eating predators at and/or near a boundary of said fish-containing area.

This method and this system are advantageous in that a moving image is very effective in scaring away the one or more fish eating predators. The moving image namely addresses the visual system of the one or more fish eating predators, which is typically very sensitive. The moving image therefore creates a very strong suggestion for the one or more fish eating predators that they are preyed upon and that its life is in danger. Furthermore, the inventors have found that the fish eating predators becoming habituated to such moving image can be more easily prevented than for example sounds or a single still image. Such habituation is undesired because it would mean that the one or more fish eating predators are no longer scared off and repelled. It should be appreciated that a moving image is inherently suitable for preventing such habituation. A moving image can namely be easily changed in order to surprise the one or more fish eating predators. For example, the moving image can be changed such that another type of predator is shown. In another example, the size of the depicted predator can be suddenly increased herewith creating a suggestion that the predator of the one or more fish eating predators is approaching the one or more fish eating predators. In general, the term “moving image” may indicate a still image (fixed content) that moves or changes location/orientation or a dynamic image (changing content) that is provided at a fixed location or in addition also moves or changes location/orientation. In principle, the more the fish eating predator is surprised, the less likely undesired habituation will occur. Hence, the above described method and system are highly effective in repelling fish eating predators from a fish-containing area within a sea, fjord, river or lake.

A further important advantage of the system and method is that they are also effective in dimmed/dark conditions. In contrast, if objects are used as dummy predators the fish eating predators will not see these if it is dark.

Also, the provided image can be easily adapted to the current environmental conditions at the boundary of the fish containing area. For example, the light intensity that is used to provide the moving image can be increased when water is cloudy or decreased when the water is very clear.

The aquaculture system may be fish farming system.

The fish-containing area is for example a fjord and said boundary is positioned at the entrance of the fjord, i.e. at the boundary between open sea and fjord. In such case, the fjord may comprise one or more enclosures, such as sea cages, for keeping the fish within respectively enclosed one or more areas in the fjord. As such, the one or more enclosures are configured to keep the fish inside the fjord, i.e. inside the fish-containing area. The moving image may thus be provided at the boundary between fjord and open sea (and the image provisioning system may be configured to do so). The fish containing area is typically a volume within the sea, fjord, river or lake.

The aquaculture system may also be a fish enclosure. In that case, the fish-containing area may be understood to be the area that is enclosed by the fish enclosure and typically the boundary of the fish-containing area is formed by one or more barriers of the fish enclosure that are configured to keep the fish inside the enclosed area. The moving image may thus be provided at and/or near these one or more barriers and the image provisioning system may be configured to do so.

The moving image is preferably provided under water. The moving image is preferably observable by the fish eating predator if it is at and/or near and/or approaching said boundary. Providing the moving image at and/or near the boundary may be understood such that the moving image is provided at a position where it, if the moving image indeed scares the one or more fish eating predators, prevents the one or more fish eating predators from crossing the boundary into the fish-containing area. The moving image may also be referred to as a video.

In a concrete example, the fish are salmon that are held in sea cages of a fish farm and the one or more fish eating predators are seals. Then, the predator of the one or more fish eating predators may be a killer whale. Hence, in such case, a moving image of a killer whale is provided at and/or near the boundary of the fish-containing area.

The one or more fish eating predators may be a pinnipeds. Pinnipeds are carnivorous, fin-footed, semiird marine mammals. Examples of pinnipeds are seals, sea lions and walruses. Some examples of seals are ringed seal, Baikal seal, Caspian seal, spotted seal, harbor seal, grey seal, ribbon seal, harp seal, hooded seal, bearded seal, Weddell seal, leopard seal, crab eater seal, Ross seal, southern elephant seal, northern elephant seal, Mediterranean monk seal, Hawaiian monk seal, Antarctic fur seal, Guadalupe fur seal, Juan Fernández fur seal, Galápagos fur seal, Arctocephalus forsteri, subantarctic fur seal, brown fur seal, northern fur seal. Some examples of sea lions are Australian sea lion, New Zealand sea lion, South American sea lion, California sea lion, Galápagos sea lion, Japanese sea lion, Steller sea lion.

It should be appreciated that providing an image of a silhouette of a predator of the fish-eating predator may be considered to be a provisioning of an image of a predator of the fish-eating predator.

In an embodiment of the method, providing the moving image comprises providing, in succession, a series of still images of the predator of the one or more fish eating predators such that an impression is created that the predator of the one or more fish eating predators is moving.

In an embodiment of the system, the image provisioning system is configured to provide said moving image by providing, in succession, a series of still images of the predator of the one or more fish eating predators such that an impression is created that the predator of the one or more fish eating predators is moving.

In an embodiment of the method, providing said moving image comprises projecting the moving image on a surface at and/or near said boundary.

In an embodiment of the system, the image provisioning system comprises a projection system for projecting the moving image on a surface at and/or near said boundary.

This embodiment provides great flexibility in terms of the position where the moving image can be provided. This in contrast to using a light-emitting display, wherein, of course, the image can only be provided at the light emitting display.

In an embodiment of the method, projecting the moving image comprises projecting the moving image on a projection screen at and/or near said boundary and/or comprises projecting the moving image on a bottom of said sea, fjord, river or lake, at and/or near said boundary.

In an embodiment of the system, the projection system is configured to project the moving image on a bottom of said sea, fjord, river or lake, and/or wherein the one or more enclosures comprise a projection screen wherein the projection system is configured to project the moving image on said projection screen.

In these embodiments of the method and system respectively, the projection screen may be a barrier of a fish enclosure. To illustrate, the mesh of for example a sea cage or sea pen or net pen can be used as projection screen. Thus, the projection screen may be such mesh. This is advantageous in that no separate screens need to be installed at and/or near the boundary of the fish-containing area.

In an embodiment of the method, said moving image is projected using light of a first wavelength or wavelength range. Such embodiment may comprise projecting light of a second wavelength or wavelength range, different from the first wavelength or wavelength range, at and/or near said projected moving image for distorting the projected moving image for the fish contained in said fish-containing area.

In an embodiment of the aquaculture system, the projection system is configured to project the moving image using light of a first wavelength or wavelength range and configured to project light of a second wavelength or wavelength range, different from the first wavelength or wavelength range, at and/or near said projected moving image for distorting the projected moving image for the fish contained in said fish-containing are.

Advantageously, these embodiment reduce the stress as experienced by the fish contained in the fish-containing area because the distortion for the fish. Typically, the predator of the one or more fish eating predators is itself also a predator of the fish contained in the fish-containing area. Therefore, if the fish inside the fish-containing area would be able to see the moving image of this predator, then they would likely be stressed by it. Such stress for the fish is preferably prevented because it can hamper the growth and development of the fish which may reduce the yield of a fish farm.

Non-mammal vertebrates (like fish) typically have a more complex color vision system than mammals. Note that the one or more fish eating predators are typically marine mammals that are adapted for low-light vision. Typically, such mammals have only a single cone (are monochromats) so they can only perceive light intensity and cannot distinguish light colors. Therefore, one way of distorting the moving image for the fish is to project low intensity light of different colors onto the moving image of the predator. Herein, the low intensity of the light may serve to distort the moving image for the fish eating predator as little as possible, whereas the different colors may serve to distort the moving image for the fish so that the fish cannot perceive the predator.

In this embodiment, another image, for example another moving image, may be projected over the moving image using the light of the second wavelength or wavelength range. This other image for example is an image of one or more animals that are non-threatening to the fish contained in the fish-containing area. However, the light of the second wavelength or wavelength range may also be used to project a blurring spot over the moving image over the moving image.

The eyes of the fish contained in said fish-containing may be more sensitive to light of the second wavelength or wavelength range than to light of the first wavelength or wavelength range.

One wavelength range being different from another wavelength range may be understood as non-overlapping wavelength ranges in that there are no wavelengths that are present in both wavelength ranges. Alternatively, one wavelength range being different from another wavelength range may be understood as one wavelength range containing a wavelength that is not present in the other wavelength range.

In an embodiment of the method, providing said moving image comprises rendering the moving image on a light-emitting display device that is positioned at and/or near said boundary.

In an embodiment of the system, the image provisioning system comprises a light-emitting display device for displaying the moving image.

These embodiments of the method and system respectively are advantageous in that the actually provided image can be controlled accurately. This in contrast to for example projected images, which may be distorted by light blocking elements between the projection system and the position where the image is to be projected. In that sense, these embodiments are very suitable for use in murky waters, where image projection may be troublesome.

A further advantage of using a light-emitting display is that it can be easily directed away from the fish in the fish-containing area. This prevents that the fish are stressed by images that are provided on the light-emitting display device.

In an embodiment, the method further comprises detecting the one or more fish eating predators near said fish-containing area, and, based on detecting the one or more fish eating predators near said fish-containing area, providing the moving image of the predator of the one or more fish eating predators at and/or near said boundary.

In an embodiment, the aquaculture system further comprises a detection system for detecting the one or more fish eating predators near or approaching said area and a data processing system. The data processing system is adapted to receive one or more signals from the detection system, the one or more signals indicating whether or not the one or more fish eating predators are near or approaching said area, and is adapted to, based on the received one or more signals, cause the image provisioning system to provide the moving image of the predator of the one or more fish eating predators at and/or near the boundary of said fish-containing area.

These embodiments of the method and system respectively are advantageous in that the image is only provided when necessary, i.e. when there are fish-eating predators that need to be repelled. As such, these embodiments are energy-efficient.

In an embodiment of the method, detecting the one or more fish eating predators near said fish-containing area comprises detecting behavior of one or more fishes inside the fish-containing area, which behavior is indicative of the one or more fish eating predators being near or approaching said fish-containing area.

In an embodiment of the aquaculture system, the detection system is configured to detect behavior of one or more fishes inside the fish-containing area, which behavior is indicative of the one or more fish eating predators being near or approaching said fish-containing area.

These embodiments of the method and system respectively are advantageous in that they obviate the need to install detectors that are directed to the outside of the fish-containing area. Typically, fish farms have already installed detectors for monitoring the fish and these embodiments allow to use these detectors for detecting one or more fish eating predators near the fish-containing area based on monitoring the fish behavior inside the cage.

One or more cameras may for example be used to monitor the behavior of the fish inside the fish-containing area. The detection system may thus comprise one or more cameras configured to capture images of the fish inside the fish-containing area.

In an embodiment, the method further comprises providing sound signals at and/or near said boundary, wherein the sound signals resemble sound signals that are produced by a predator of the one or more fish eating predators and/or resemble sound signals that are produced by a fish-eating predator being in danger, e.g. being under attack from a higher ranking predator.

In an embodiment, the aquaculture system further comprises a sound provisioning system that is configured to provide sound signals at and/or near said boundary, wherein the sound signals resemble sound signals that are produced by the predator of the one or more fish eating predators. The sound signals may additionally or alternatively resemble sound signals that are produced by a fish-eating predator being in danger, e.g. under attack from a higher ranking predator.

These embodiments of the method and system respectively are advantageous in that they provide an even stronger suggestion to the one or more fish eating predators that a predator of the one or more fish eating predators is present, which makes these embodiments even more effective in repelling the one or more fish eating predators.

Preferably, the sound signals are directed away from the fish in the fish-containing area and preferably the sound provisioning system is configured to direct the sound signals away from the fish in the fish-containing area. This prevents, at least to some extent, that the sound signals stress the fish in the fish-containing area.

In an embodiment, the method further comprises monitoring the effectiveness of the method according to any of the preceding claims in repelling the one or more fish eating predators from the fish-containing area. Herein monitoring the effectiveness comprises repeatedly, e.g. continuously, monitoring whether one or more fish eating predators are at and/or near and/or approaching the boundary of the fish-containing area. In this embodiment, the method further comprises determining that the effectiveness is lower than a desired level of effectiveness and, based on this determination, providing, optionally instead of said moving image, a further moving image of a predator of the one or more fish eating predators at and/or near the boundary.

In an embodiment of the aquaculture system, the data processing system is adapted to, based signals from a detection system as described herein, monitor the effectiveness of the system in repelling the one or more fish eating predators from the fish-containing area by repeatedly, e.g. continuously, monitoring, based on signals from the detection system whether one or more fish eating predators are at and/or near and/or approaching the boundary of the fish-containing area. Herein the data processing system is further configured to determine that the effectiveness is lower than a desired level of effectiveness, and configured to, based on this determination, cause the image provisioning system to provide, optionally instead of said moving image, a further moving image of a predator of the one or more fish eating predators at and/or near the boundary.

These embodiments enable that the method and system remain effective. If the one or more fish eating predators have become accustomed to the moving image, the further moving image can cause a surprising effect that may scare them off again.

The further image may be an image of another predator of the fish-eating predator. To illustrate, first a moving image of a killer whale is provided at the boundary. Once the data processing system that the level of effective drops below a minimum level a further moving image of a shark may be provided, in addition to or instead of the moving image of the killer whale.

The further image may also be an image of the same predator, however, with differing characteristics. The further moving image may for example be simply larger than the initially provided moving image.

The number of one or more fish eating predators at and/or near and/or approaching the boundary may be repeatedly counted or estimated.

In an embodiment, the method further comprises using a machine-learning algorithm that is configured to determine the moving image that is to be provided at and/or near said boundary based on input data, wherein the input data indicate for a plurality of already provided moving images respective measured levels of effectiveness.

In an embodiment, the aquaculture system comprises a data processing system that is adapted to execute a machine learning algorithm that is configured to determine the moving image that is to be provided at and/or near said boundary based on input data, wherein the input data indicate for a plurality of already provided moving images respective measured levels of effectiveness.

These embodiments of the method and system respectively are advantageous in that they enable to continuously search for the most effective moving images to be provided, preferably in an automatic way.

Preferably, the input data also comprises information representing environmental parameters.

One aspect of this disclosure relates to a computer program comprising instructions to cause an embodiment of the aquaculture system as described herein to perform an embodiment of the method as described herein.

One aspect of this disclosure relates to a computer-readable medium having stored thereon such computer program.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 schematically shows an embodiment of the aquaculture system that comprises a projection system configured to project on a screen;

FIG. 2 schematically shows an embodiment of the aquaculture system that comprises a light-emitting display device;

FIG. 3 schematically shows an embodiment of the aquaculture system that comprises a ribbon-shaped light-emitting display device;

FIG. 4 schematically shows an embodiment of the aquaculture system that comprises a projection system that is configured to project on a bottom;

FIG. 5 schematically shows an embodiment of the aquaculture system that comprises a detection system for detecting one or more fish eating predators;

FIG. 6 is a flow chart illustrating embodiments of the method comprising providing the moving image based on the detection of fish-eating predators;

FIG. 7 illustrates how, according to an embodiment, the aquaculture system can be implemented in a fjord;

FIG. 8 illustrate how, in an embodiment, the moving image can be distorted for the fish in the fish-containing area.

FIG. 9 is a data processing system according to an embodiment.

### DETAILED DESCRIPTION OF THE EMBODIMENTS

In the figures, identical reference numbers indicate identical or similar elements.

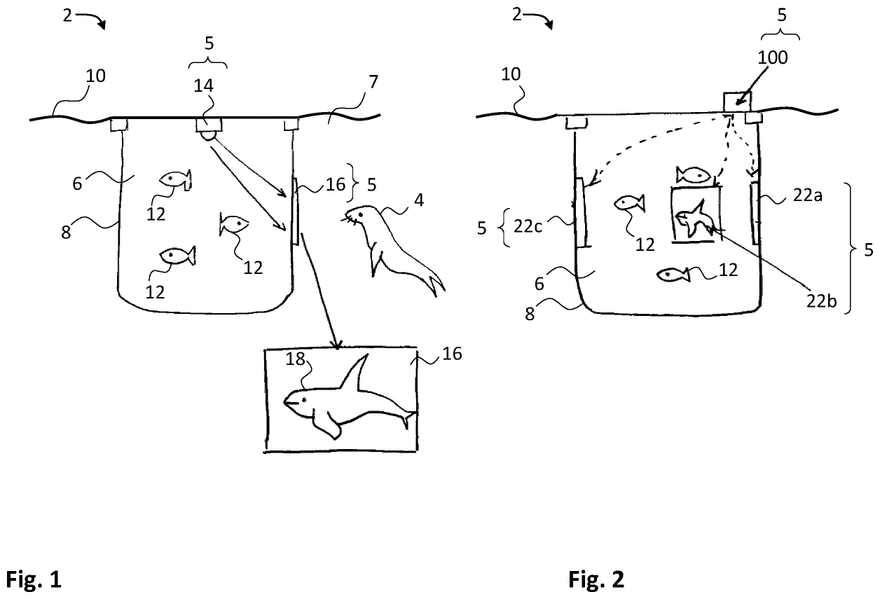

FIG. 1 schematically shows an embodiment of the aquaculture system 2 that is configured to repel one or more fish eating predators 4 from a fish-containing area 6. The aquaculture system 2 may be a fish farm that grows fish for consumption. Examples of such fish are salmon, tuna, carp fish, such as grass carp, silver carp, common carp, Roho labeo, Nile tilapia, milkfish, trout, et cetera. The one or more fish eating predators 4 may be pinnipeds, such as seals, sea lions, sea leopards, walruses.

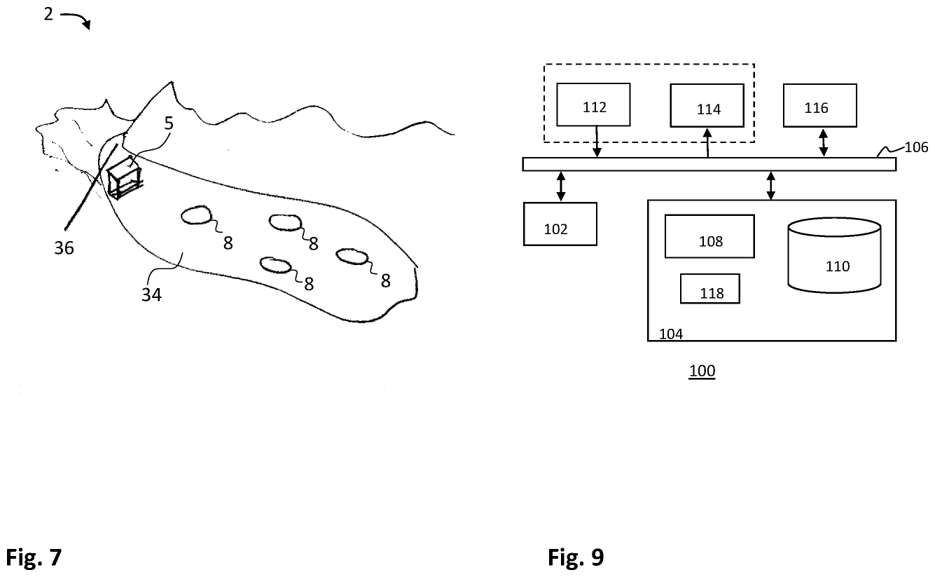

The system 2 comprises one or more enclosures 8 for keeping fish 12 within the fish-containing area 6 within a sea, fjord, river or lake 7. The enclosure 8 may form the boundary of the fish-containing area 6, however, this is not necessarily the case as shown with reference to FIG. 7. The one or more enclosures typically comprises nets or cage structures below the water surface 10 for preventing the fish 12 from escaping the area 6. The system 2 also comprises an image provisioning system 5 for providing a moving image of a predator 18 of the one or more fish eating predators 4 at and/or near the boundary 8 of the fish-containing area 6.

Examples of predators are sharks, such as white sharks, and killer whales. These animals prey on pinnipeds such as seals, sea lions and sea leopards.

The image provisioning system 5 may be understood to be configured to provide said moving image 18 by providing, in succession, a series of still images of the predator 18 of the one or more fish eating predators 4 such that an impression is created that the predator 18 of the one or more fish eating predators 4 is moving. For example, the moving image may create the impression that the predator 18 is swimming around the enclosure 8.

In the embodiment of FIG. 1, the image provisioning system 5 comprises a projection system 14 for projecting the moving image 18 on a surface 16 at and/or near said boundary 8. In particular, as shown, the one or more enclosures 8 comprise a projection screen 16, wherein the projection system 14 is configured to project the moving image 18 on said projection screen 16. The projection screen 16 may also be understood to be part of the projection system 14 and of the image provisioning system 5. The projection screen 16 may for example be provided on a net or cage structure of an enclosure. Of course, more than one, for example two, three, four, five or even more projection screens may be provided on every enclosure 8.

FIG. 2 schematically shows an embodiment of the aquatic system 2, the image provisioning system 5 comprises a light-emitting display device 22 for displaying the moving image. In the depicted embodiment, the enclosure 8 comprises the light-emitting display device 22 in the sense that one or more displays 22a, 22b, 22c are provided on the enclosure. The light-emitting display device may thus comprise one or more light-emitting displays. Preferably, these are waterproof light-emitting displays because they are typically positioned under the water surface 10.

In the depicted embodiment, a data processing system 100 is implemented that is configured to control the respective displays 22a, 22b, 22c of the light-emitting display device. Such data processing system 100 for example comprises a computer-readable storage medium having stored the moving image that is to be provided on the one or more displays 22a, 22b, 22c. Additionally, such computer-readable storage may comprise further moving images as described herein, for example of different predators of the fish eating predator.

In an embodiment, the light-emitting display device comprises a grid comprising a plurality of light emitting diodes (LEDs) as for example described in WO2014013400A2. Advantageously, such grid can be positioned on enclosure 8 and provide the moving image of predator 18. In one embodiment, such grid can even be used as the barrier of the enclosure 8 for keeping fish inside the fish-containing area 6. Preferably, such a grid is water-proof as the moving images are typically provided under water. Such grid can be made water proof by manners known in the art, such as be incorporating the grid in waterproof plastic casings.

In an embodiment, the light-emitting display device comprises one or more LED walls that can be moved in the water from enclosure to enclosure.

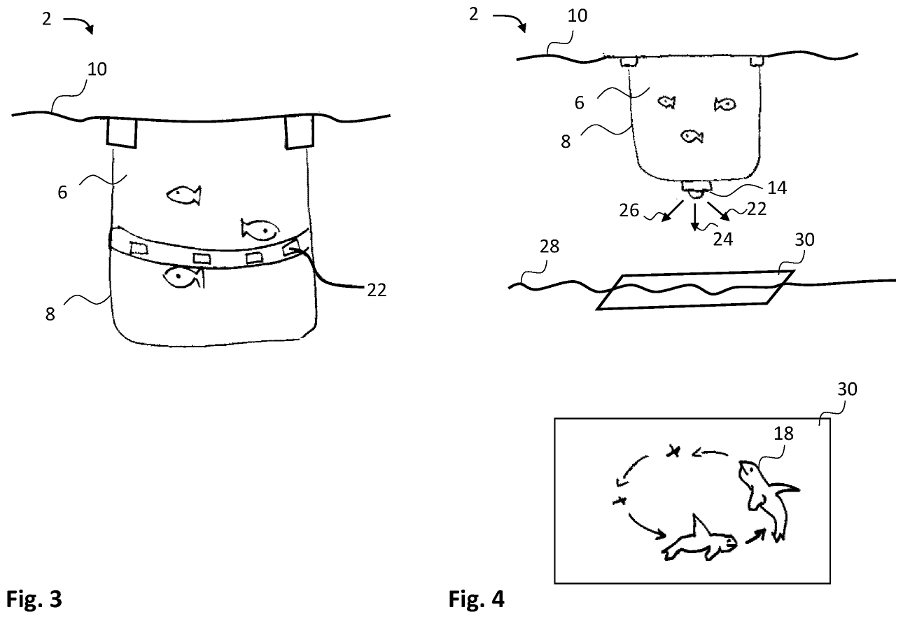

FIG. 3 schematically shows an embodiment of the aquaculture system 2 that comprises a ribbon-shaped light-emitting display device 22. Such ribbon-shaped light-emitting display device 22 is e.g. a flexible display or a segmented long array of displays that forms a continuous or quasi-continuous display. This allows to display moving images, such as e.g. the image of the killer whale that circles around the fish-containing area.

Alternatively, the ribbon 22 can be a passive projection screen or the cage structure itself, onto which, using a dynamic and rotating directional projection system, images are projected for the same purpose.

FIG. 4 schematically shows an embodiment of the aquaculture system 2 that comprises a projection system 14 that is configured project the moving image 18 on an area 30 of a bottom 28 of the sea, fjord, river or lake where the aquaculture system 2 is positioned.

In the depicted embodiment, the projection system 14 is configured to direct the projection light in various directions 22, 24, 26 subsequently so that the image 18 of the predator of the one or more fish eating predators is present at different locations in area 30 on the bottom of the sea, fjord, river, lake.

In an embodiment, the aquaculture system 2 further comprise a sound provisioning system (not shown) that is configured to provide sound signals at and/or near said boundary, wherein the sound signals resemble sound signals that are produced by the predator of the one or more fish eating predators.

Further examples of sound signals that may be provided are:
sound signals resembling sound signals produce by the orca or shark predators.
sound signals resembling the hunting ‘sound’ of a predator of a fish eating predator, such as the hunting sound of an orca. Orcas produce three categories of sounds: clicks, whistles, and pulsed calls. Clicks are believed to be used primarily for navigation and discriminating prey and other objects in the surrounding environment.
sound signals resembling the sound of an attack onto a fish eating predator.
sound signals resembling alerting sounds of wounded and/or dying fish eating predators.

In an embodiment, the method may comprise providing directional projection of ultrasound toward the one or more fish eating predators. Such ultrasound is namely typically used by e.g. an orca to locate their prey. Such directionality allows shielding the effect from the salmons such that these are not affected/stressed.

Further, olfactory stimuli may also be provided to repel the fish eating predators.

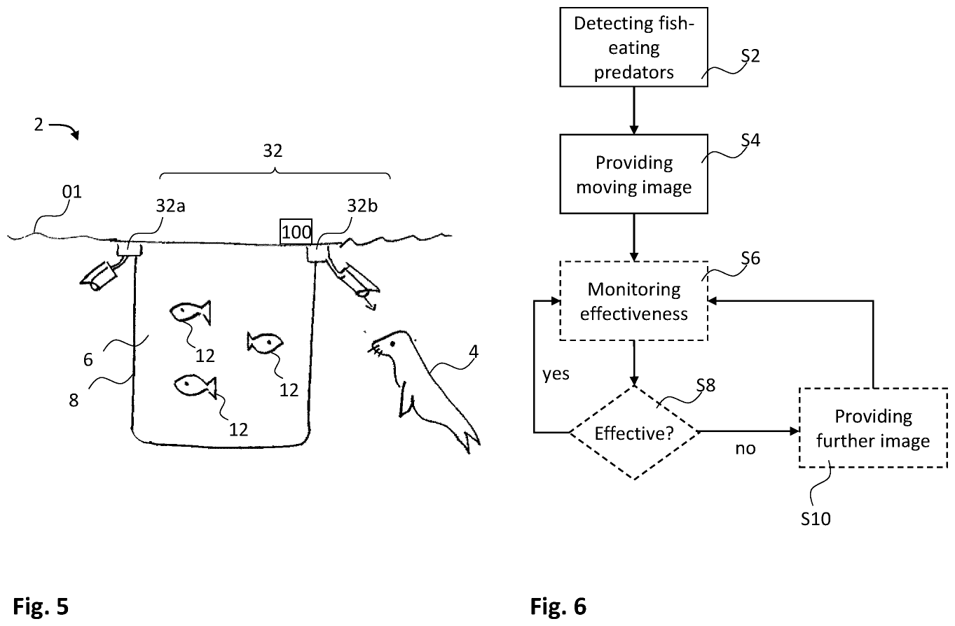

FIG. 5 illustrates an embodiment of the aquaculture system 2 that comprises a detection system 32 for detecting the one or more fish eating predators 4 near or approaching said area 6 and a data processing system 100. The data processing system 100 is adapted to receive one or more signals from the detection system. These one or more signals may be wireless or wired signals. The one or more signals indicate whether or not the one or more fish eating predators 4 are near or approaching said area 6, and is adapted to, based on the received one or more signals, cause the image provisioning system (not shown in FIG. 5) to provide the moving image of the predator 18 of the one or more fish eating predators 4 at and/or near the boundary of said fish-containing area 6.

The detection system 32 may comprise any number of suitable detectors. In the depicted embodiment, the detection system comprises a plurality of cameras 32a, 32b to capture images of the fish eating predators 4, if they are present near the boundary of the fish containing area 6. However, additionally or alternatively, the detection system 32 may comprise one or more microphones that are configured to capture the sounds produced by the fish eating predators 4.

The data processing system 100 may be configured to detect the presence of one or more fish eating predators 4 based on the captured images and/or based on the sounds captures by the microphones. To this end, the data processing system may recognize patterns in the recorded images and/or sounds that are associated with one or more fish-eating predators being at and/or near the fish containing area 6.

In an embodiment of the aquaculture system 2 the detection system 32 is configured to detect behavior of one or more fishes inside the fish-containing area (not shown in FIG. 5), which behavior is indicative of the one or more fish eating predators being near or approaching said fish-containing area. Such detection system 32 may comprise one or more cameras to capture images of the fish inside the fish-containing area 6. The data processing system 100 may then be configured to recognize patterns in the captured images associated with behavior of the fish indicative of one or more fish eating predators 4 being present.

FIG. 6 is a flow chart illustrating an embodiment of the method for repelling one or more fish eating predators wherein the moving image is provided based on a detection of the one or more fish eating predators. Step S2 comprises detecting the one or more fish eating predators near said fish-containing area, in particular near the boundary of the fish-containing area. For this step any of the detection system as described herein may be used. Then, step S4 comprises, based on detecting the one or more fish eating predators near said fish-containing area, providing the moving image of the predator of the one or more fish eating predators at and/or near said boundary.

Steps S6, S8 and S10 are optional steps that may be performed in a further embodiment. Step S6 comprises monitoring the effectiveness of the method in repelling the one or more fish eating predators from the fish-containing area. This step may be understood to comprise monitoring the effectiveness of the provided moving image in repelling the one or more fish eating predators. In this step, monitoring the effectiveness comprises repeatedly, e.g. continuously, monitoring whether one or more fish eating predators are at and/or near and/or approaching the boundary of the fish-containing area. Step S8 comprises determining that the effectiveness is lower than a desired level of effectiveness.

Step S6 may be performed by counting, or estimating, how many fish-eating predators are present in an area near the fish-containing area. Such counting or estimating may be performed based on direct detections of one or more fish eating predators, for example using cameras or microphones as described herein. Additionally or alternatively, such counting or estimating may be performed based on indirect detection of one or more fish eating predators, e.g. based on detections of behavior of the fish inside the fish containing area indicative of one or more fish eating predators being present. An example of such behavior is the movements of the school of fish that is abnormal. If such indirect detection of the one or more fish eating predators is implemented, then normal behavior is indicative of the fish-eating predator not, or no longer, being present.

The method may be deemed effective in step S8 if this number decreases at a rate higher than a minimum threshold rate. In such case, the desired level of effectiveness may be given by the minimum threshold rate. Additionally or alternatively, the method may be deemed effective in step S8 if the number of counted or estimated fish eating predators in an area near the fish-containing area is below a maximum threshold number of fish-eating predators. In such case, the desired level of effective may be given by this maximum threshold number of fish-eating predators.

In the depicted flow chart, if the method is no longer deemed effective in step S8, then step S10 is performed which comprises providing, optionally instead of said moving image, a further moving image of a predator of the one or more fish eating predators at and/or near the boundary. The further moving image may be an escalation in the sense that it for example has brighter intensities than the initially provided moving image, or has faster dynamics. Additionally or alternatively, step S10 comprises providing an another, additional stimuli, such as sound signals as described herein or an image of another type, such as a still image.

After step S10, again step S6 may be performed. In an embodiment, the moving image is no longer provided if for some predetermined time period, no fish-eating predators have been detected. This predetermined time period is for example five minutes. In such case, the method may be stopped altogether until again one or more fish eating predators are detected by the detections system.

In an embodiment, the method comprises using a machine-learning algorithm that is configured to determine the moving image that is to be provided at and/or near said boundary based on input data, wherein the input data indicate for a plurality of already provided moving images respective measured levels of effectiveness. The machine-learning algorithm is for example an unsupervised machine learning algorithm or be based on reinforcement learning known in the art. In any case, the aim for these algorithms is to perform automated actions, i.e. to provide moving images, such that fish eating predators that are present near the fish-containing area are effectively repelled.

Preferably, the input data into the machine learning algorithm also comprises environmental information, which indicates under which circumstances, such as temperature, visual condition of the water, time of day, certain moving images were presented and their effectiveness. This allows the machine learning algorithm to select the appropriate moving image for any given circumstances.

FIG. 7 illustrates how the methods and systems described herein can be implemented in a fjord 34. Herein, one or more enclosures 8 are present in fjord 34 and the image provisioning system 5 is configured to provide the moving image of the predator 18 of the fish eating predators at the boundary 36 of the fish containing-area. The fish-containing area in this embodiment is the fjord 34. Further, the boundary of the fjord is at the entrance 36 of the fjord. This embodiment allows to repel fish eating predators from the fjord 34.

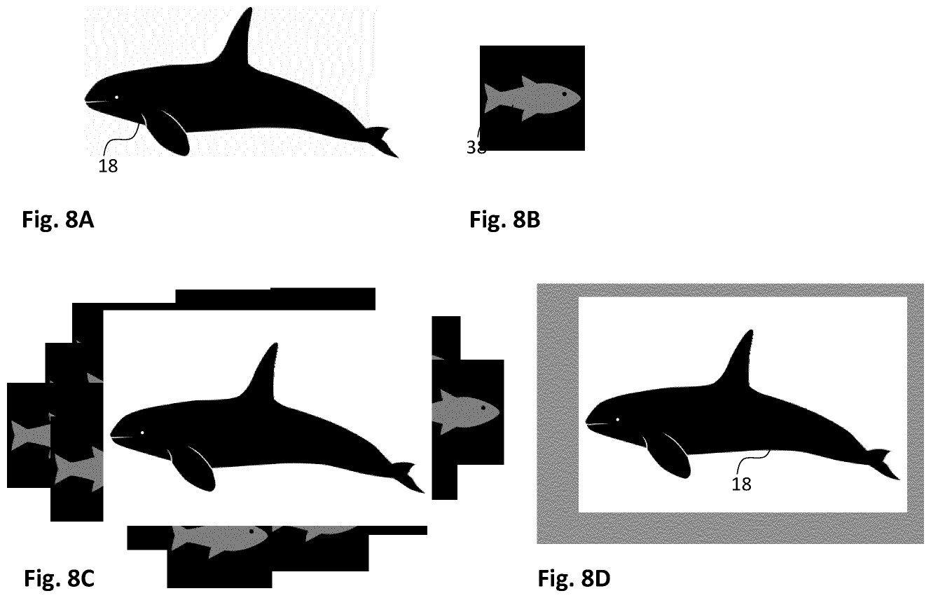

FIG. 8 illustrate how the projection of light of a second wavelength or wavelength range, different from the first wavelength range or wavelength range, can aid in distorting the moving image for the fish inside the fish containing area.

In particular, FIG. 8A shows image 18 of a predator of the fish eating predator 4, namely of a killer whale. FIG. 8B shows an image 38 of a fish that is non-threatening to the fish inside the fish-containing area. Image 18 is projected using light of a first wavelength and image 38 is projected using light of a second wavelength.

Preferably, the light of the second wavelength has a relatively low intensity with respect to the light of the first wavelength. This ensures that the fish eating predator, which can typically only distinguish light intensities, and cannot distinguish between colors of light, can still clearly see the image 18 of the killer whale.

As shown in FIG. 8C, light of the second wavelength can then be projected at the image 18 of the predator. FIG. 8C may be understood to depict the image as perceived by the fish eating predator 4 (sea lion for example). The image 18, which has much higher intensity than the light of the second wavelength, is clearly discernable for the fish eating predators 4 and can therefore effectively repel them.

However, the fish inside the fish containing area are sensitive to the color of light. Therefore, the light of the second wavelength can be chosen such that the fish perceive it as very intense herewith distorting the image of the killer whale for the fish in the fish-containing area.

Although FIG. 8 show that the light of the second wavelength is used to image a non-threatening fish, it may also be used to create a background for the image 18 as depicted in FIG. 8D. Again, the background may have such light color that it distorts the image 18 for the fish. However, since the intensity of the light of the second wavelength is relatively low, the first eating predator 4 (seal for example) can distinguish the image 10 of the predator 18.

A specific wavelength that might be used for the second wavelength is NIR (approximately 800 nm) that is perceived by fish and typically not by pinnipeds, such as sea lions. Herewith, the distortion for the fish takes place unnoticed for the fish eating predators.

The second wavelength range may also comprise UV light.

Some fish species also ‘see’ UV light (360 nm), pinnipeds do not. So UV might be used to ‘overexpose’ a visual light image.

It should be appreciated that embodiments of the aquaculture system described herein comprise data processing, the data processing system may be configured to control the operation of the respective elements of the aquaculture system, such as configured to control a detection system described herein, an image provisioning system as described herein, a projection system as described herein, a light-emitting display device as described herein, cameras, et cetera. Hence, the data processing system may function as a control module for the aquaculture system.

FIG. 9 depicts a block diagram illustrating a data processing system according to an embodiment. As shown in FIG. 9, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 1 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 9, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 9) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

In one aspect of the present invention, the data processing system 100 may represent a detection system or part thereof, projection system or part thereof, light-emitting display device or part thereof, as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method for repelling one or more fish eating predators from a fish-containing area within a sea, fjord, river or lake, the method comprising:
providing, using an image provisioning system, a moving image of a predator of the one or more fish eating predators at and/or near a boundary of the fish-containing area,
wherein projecting the moving image comprises projecting the moving image on a projection screen at and/or near said boundary and/or comprises projecting the moving image on a bottom of said sea, fjord, river or lake, at and/or near said boundary,
wherein said moving image is projected using light of a first wavelength or wavelength range, the method further comprising:
projecting light of a second wavelength or wavelength range, different from the first wavelength or wavelength range, at and/or near said projected moving image for distorting the projected moving image for the fish contained in said fish-containing area.

2. The method according to claim 1, wherein providing the moving image comprises providing, in succession, a series of still images of the predator of the one or more fish eating predators such that an impression is created that the predator of the one or more fish eating predators is moving.

3-5. (canceled)

6. The method according to claim 1, wherein providing said moving image comprises rendering the moving image on a light-emitting display device that is positioned at and/or near said boundary.

7. The method according to claim 1, further comprising:
detecting the one or more fish eating predators near said fish-containing area, and
based on detecting the one or more fish eating predators near said fish-containing area, providing the moving image of the predator of the one or more fish eating predators at and/or near said boundary.

8. The method according to claim 1, wherein detecting the one or more fish eating predators near said fish-containing area comprises:
detecting behavior of one or more fishes inside the fish-containing area, which behavior is indicative of the one or more fish eating predators being near or approaching said fish-containing area.

9. The method according to claim 1, further comprising:
providing sound signals at and/or near said boundary, wherein the sound signals resemble sound signals that are produced by a predator of the one or more fish eating predators and/or resemble sound signals that are produced by a fish-eating predator being in danger.

10. The method according to claim 1, further comprising:
monitoring the effectiveness in repelling the one or more fish eating predators from the fish-containing area, wherein monitoring the effectiveness comprises:
repeatedly, e.g. continuously, monitoring whether one or more fish eating predators are at and/or near and/or approaching the boundary of the fish-containing area, and the method further comprising:
determining that the effectiveness is lower than a desired level of effectiveness, and
based on this determination, providing, optionally instead of said moving image, a further moving image of a predator of the one or more fish eating predators at and/or near the boundary.

11. The method according to claim 1, further comprising:
using a machine-learning algorithm that is configured to determine the moving image that is to be provided at and/or near said boundary based on input data, wherein
the input data indicate for a plurality of already provided moving images respective measured levels of effectiveness.

12. An aquaculture system that is configured to repel a fish-eating predator from a fish-containing area, the system comprising:
one or more enclosures for keeping fish within the fish-containing area within a sea, fjord, river or lake, and
an image provisioning system adapted to provide a moving image of a predator of the one or more fish eating predators at and/or near a boundary of said fish-containing area, the image provisioning system comprising a projection system for projecting the moving image on a surface at and/or near said boundary and/or projecting the moving image on an area of a bottom of said sea, fjord, river or lake, wherein said moving image is projected using light of a first wavelength or wavelength range,
wherein the image provisioning system is adapted to project light of a second wavelength or wavelength range, different from the first wavelength or wavelength range, at and/or near said projected moving image for distorting the projected moving image for the fish contained in said fish-containing area.

13. The aquaculture system according to claim 12, further comprising:
a detection system for detecting the one or more fish eating predators near or approaching said area, and
a data processing system that is adapted to:
receive one or more signals from the detection system, the one or more signals indicating whether or not the one or more fish eating predators are near or approaching said area, and to
based on the received one or more signals, cause the image provisioning system to provide the moving image of the predator of the one or more fish eating predators at and/or near the boundary of said fish-containing area.

14. (canceled)

15. A non-transitory computer-readable medium having stored thereon instructions, the instructions when executed by a processor of an agriculture system cause the processor to perform the method of claim 12.

16. The method according to claim 1, wherein projecting light of the second wavelength or wavelength range comprises projecting another image over the moving image using the light of the second wavelength or wavelength range.

17. The method according to claim 1, wherein projecting light of the second wavelength or wavelength range comprises projecting a blurring spot over the moving image.

18. The method according to claim 1, where the light of the second wavelength or wavelength range has a relatively low intensity with respect to the light of the first wavelength or wavelength range; and
where the second wavelength or wavelength range is NIR or UV.
